(19) United States
(12) Patent Application Publication
(10) Pub. No.: US 2026/0189995 A1
(43) Pub. Date: Jul. 2, 2026

(54) Methods And Apparatus For Improving Handover Processing In Mobile Communications

(71) Applicant: MediaTek Singapore Pte. Ltd., Singapore (SG)

(72) Inventors: Miao Wang, Beijing (CN); Tsang-Wei Yu, Hsinchu City (TW); Kai-Po Chang, Hsinchu City (TW)

(73) Assignee: MediaTek Singapore Pte. Ltd., Singapore (SG)

(21) Appl. No.: 19/433,029

(22) Filed: Dec. 25, 2025

(30) Foreign Application Priority Data
Dec. 27, 2024 (WO) PCT/CN2024/143048
Dec. 15, 2025 (CN) 202511892521.7

(51) Int. Cl. H04W 36/00; H04W 72/23

(52) U.S. Cl. CPC H04W 36/0072; H04W 36/0058; H04W 72/23

(57) ABSTRACT

Various solutions for improving handover processing in mobile communications with respect to an apparatus and a network node are described. An apparatus may determine a first part and a second part of handover processing. The second part of the handover processing causes an interruption with a source network node. The apparatus may determine a random access channel occasion (RO) of a target network node. The apparatus may perform the second part of the handover processing after the first part of the handover processing and right before the RO.

### CROSS REFERENCE TO RELATED PATENT APPLICATION(S)

The present disclosure is part of a non-provisional application claiming the priority benefits of International Application No. PCT/CN2024/143048, filed on 27 December 2024, and CN Application No. 202511892521.7, filed 15 December 2025, the contents of which herein being incorporated by reference in their entirety.

### TECHNICAL FIELD

The present disclosure is generally related to mobile communications and, more particularly, to improving handover processing or cell switch with respect to apparatus and network nodes in mobile communications.

### BACKGROUND

Unless otherwise indicated herein, approaches described in this section are not prior art to the claims listed below and are not admitted as prior art by inclusion in this section.

Mobility performance is a critical metric in a wireless communication system. Researchers are working on reducing handover delays and interruptions to improve mobility performance. With shorter delay and interruption, better link quality and mobility management may be expected. For example, Layer 1 (L1)/Layer 2 (L2)-triggered mobility is designed to reduce handover delay.

Accordingly, designing appropriate handover or cell switch procedures for reducing interruption and handover delay has become a critical issue in wireless communication systems, and there is an urgent need to provide such procedures to ensure efficient and reliable operations.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to improving handover processing or cell switch with respect to apparatus and network nodes in mobile communications.

In one aspect, a method may involve an apparatus determining a first part and a second part of handover processing. The second part of the handover processing may cause an interruption with a source network node. The method may also involve the apparatus determining a random access channel occasion (RO) of a target network node. The method may further involve the apparatus performing the second part of the handover processing after the first part of the handover processing and right before the RO.

In one aspect, an apparatus may comprise a transceiver which, during operation, wirelessly communicates with a network node. The apparatus may also comprise a processor communicatively coupled to the transceiver. The processor, during operation, may perform operations comprising determining a first part and a second part of handover processing. The second part of handover processing causes an interruption with a source network node. The processor may also perform operations comprising determining a random access channel occasion (RO) of a target network node. The processor may further perform operations comprising performing the second part of the handover processing after the first part of the handover processing and right before the RO.

In one aspect, a method may involve an apparatus determining a first part and a second part of handover processing. The second part of the handover processing may cause an interruption with a source network node. The method may also involve the apparatus performing the second part of the handover processing after the first part of the handover processing. The method may further involve the apparatus receiving a reference signal (RS) from a target network node. The second part of the handover processing may be performed right before receiving the RS from the target network node or after receiving the RS from the target network node.

In one aspect, a method may involve an apparatus determining whether a user equipment (UE) performs a first part of handover processing within an uninterrupted time. The method may also involve an apparatus scheduling resources for the UE within the uninterrupted time in an event that the UE performs the first part of handover processing within the uninterrupted time.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example scenarios under schemes in accordance with implementations of the present disclosure.

FIG. 2A is a diagram depicting example scenarios under schemes in accordance with implementations of the present disclosure.

FIG. 2B is a diagram depicting example scenarios under schemes in accordance with implementations of the present disclosure.

FIG. 2C is a diagram depicting example scenarios under schemes in accordance with implementations of the present disclosure.

FIG. 2D is a diagram depicting example scenarios under schemes in accordance with implementations of the present disclosure.

FIG. 2E is a diagram depicting example scenarios under schemes in accordance with implementations of the present disclosure.

FIG. 2F is a diagram depicting example scenarios under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improving handover processing or cell switch in mobile communications. According to the present disclosure, a number of possible solutions may be implemented separately or jointly. That is, although these possible solutions may be described below separately, two or more of these possible solutions may be implemented in one combination or another.

In the current procedures, after receiving a handover command or a cell switch command, the User Equipment (UE) performs L1/L2/ Layer 3 (L3) processing first. Then, the UE may perform downlink synchronization on the target cell/network node if needed. Furthermore, UE may perform uplink synchronization on the target cell if needed. The interruption starts from the L1/L2/L3 processing.

Although in L1/L2-triggered mobility, the UE performs pre-synchronization of downlink on the target cell/network node, the UE may still need to perform downlink synchronization on the target cell before data reception due to UE mobility and channel condition changes. The data interruption starts when the UE performs L1/L2/L3 processing. The data interruption time includes waiting for Random Access Channel (RACH) occasions.

In light of these issues, various techniques, methods, schemes and/or solutions related to improving handover processing in mobile communication systems are proposed to further reduce handover interruption or delay and improve handover efficiency.

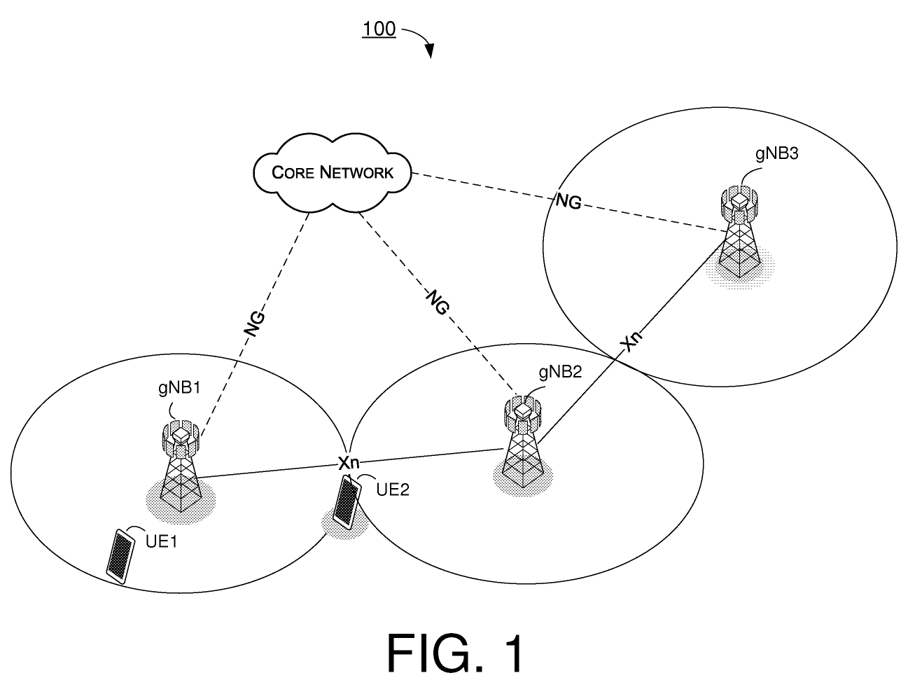

FIG. 1 illustrates an example scenario 100 of an exemplary wireless network in accordance with implementations of the present disclosure. The wireless communication system may comprise one or more base infrastructure units forming a network distributed over a geographical region. The base unit may also be referred to as an access point, an access terminal, a BS, a Node-B, an eNode-B, a gNB, or by other terminology used in the art. As an example, the base stations may serve a number of mobile stations within a serving area, for example, a cell, or within a cell sector. In some systems, one or more base stations may be coupled to a controller forming an access network that is coupled to one or more core networks.

In scenario 100, the gNB1, gNB2 and gNB3 are base stations in NR, and the serving areas of which may or may not overlap with each other. As an example, the UE1 may be in the service area of gNB1, and the UE2 may be in the overlapping service area of gNB1 and gNB2. The gNB2 may be connected with the gNB1 and the gNB3 via the Xn interface, and the gNBs may interface with the core network through backhaul links. The core network may comprise at least an Access and Mobility Management Function (AMF) and a User Plane Function (UPF). The gNBs may connect to the AMF over the Next Generation (NG) Interface. The AMF may be the control node that processes the signaling between the UEs and the core network. During the handover process, the AMF is responsible for tracking user location and managing mobility. The AMF may coordinate the switching procedure between base stations (e.g., the gNBs) to minimize service disruption. The UPF is responsible for re-routing user data according to the instructions from the AMF, helping maintain a smooth data flow.

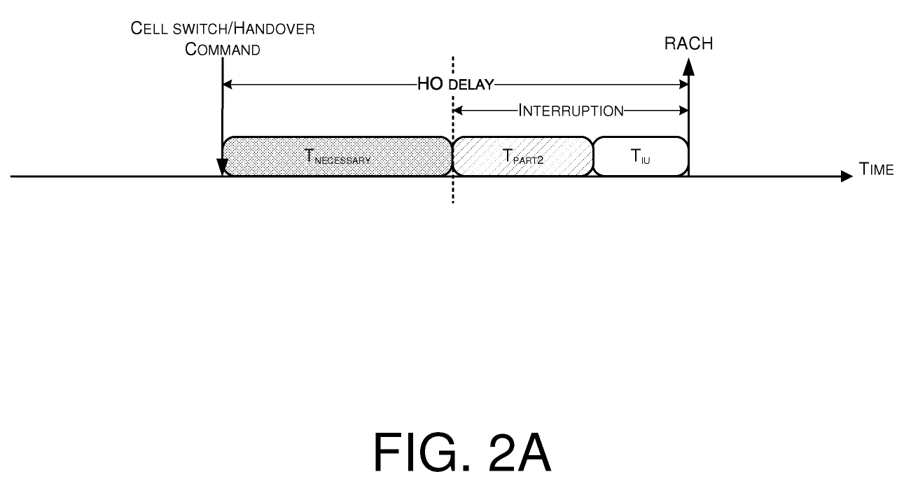

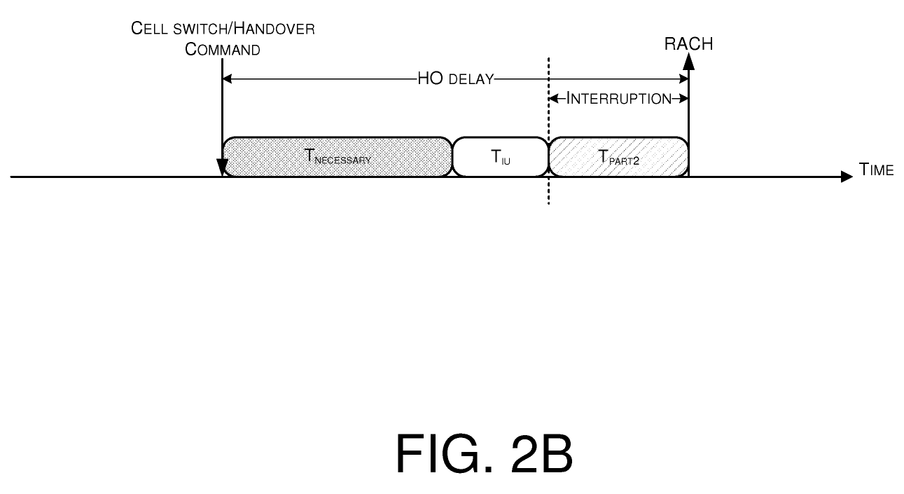

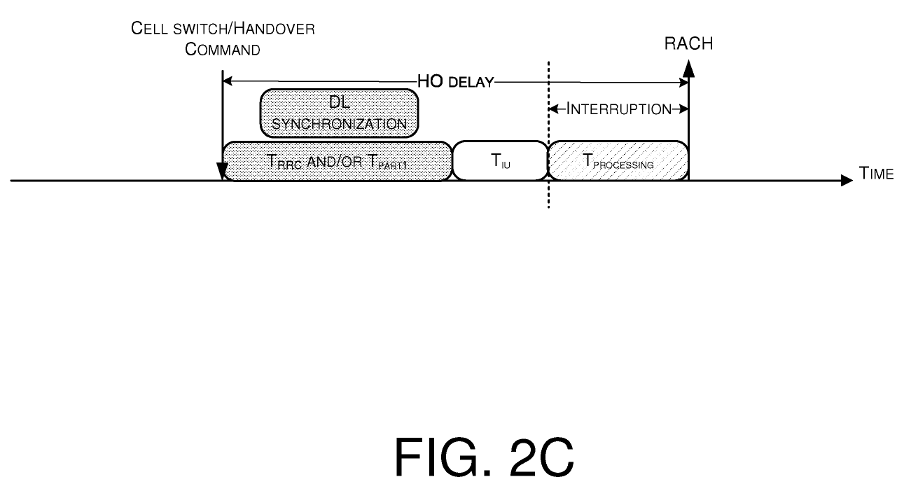

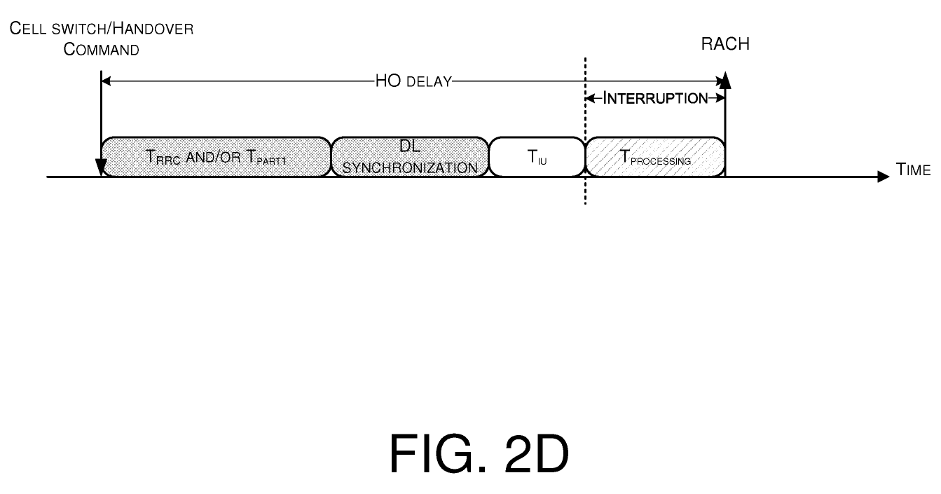

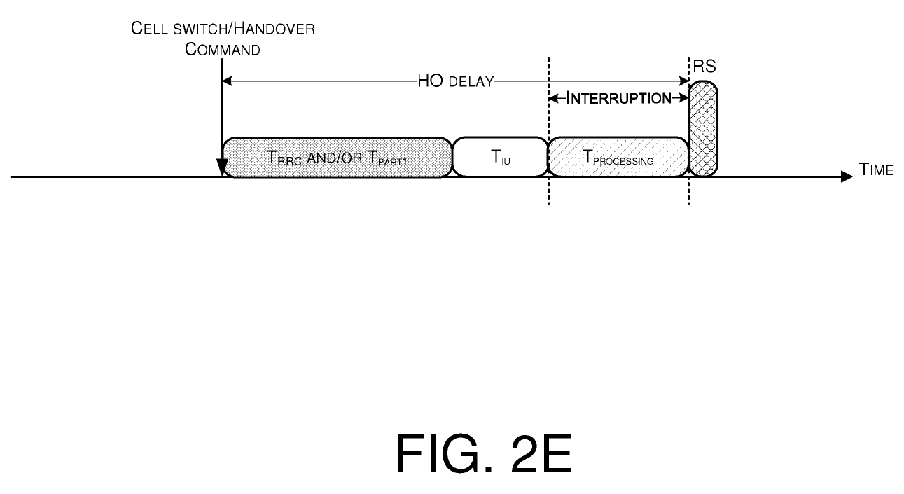

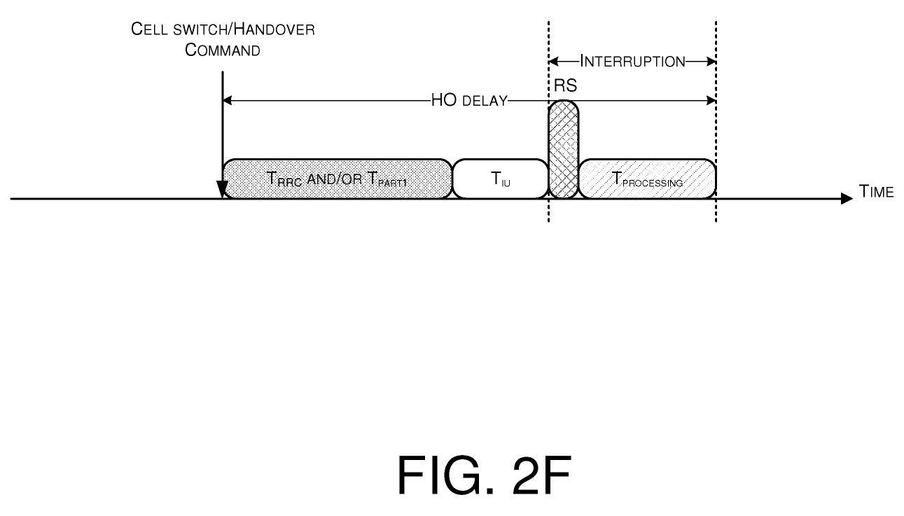

FIG. 2A is a diagram depicting example scenarios under schemes in accordance with implementations of the present disclosure. In the present disclosure, the UE (e.g., UE1 or UE2) may determine a first part of handover processing that may have no interruption on a source network node and determine a second part of the handover processing that causes an interruption with the source network node. In some implementations, the UE may perform the second part of handover processing after triggering a handover procedure (e.g., receiving a cell switch command or a handover command) and performing some necessary procedures. The handover procedure may be triggered by cell change (e.g., receiving the cell switch command or the handover command), predefined condition(s), or measurement report(s). In the present disclosure, the handover processing may be replaced by cell switch processing. The first part of the handover processing may be performed earlier than the second part. In some implementations, the necessary procedure(s) may include any one or a combination of decoding the cell switch command or the handover command, performing a Radio Resource Control (RRC) processing, performing the first part of the handover processing, and performing a downlink synchronization. The UE may perform the necessary procedure(s) during T_{necessary}. In some implementations, the first part of the handover processing may include a part of Layer 1 (L1), Layer 2 (L2), and Layer 3 (L3) processing that will not cause an interruption with the source network node. The second part of the handover processing may include another part of L1, L2, and L3 processing that will cause the interruption with the source network node.

In some implementations, the first and second parts of the handover processing may include applying parameters of the target network node and changing L1 and L2 configurations of the UE. In some implementations, the second part of the handover processing may be any one or a combination of L2 reconfiguration, L3 reconfiguration, Radio Frequency (RF) retuning, baseband retuning, and security updates; however, the present disclosure is not limited thereto. In some implementations, the RRC processing may include one or a combination of Abstract Syntax Notation One (ASN.1) decoding and validity/compliance check(s). The UE may perform the RRC processing during T_{RRC} for an RRC configuration of an L1/L2-Triggered Mobility (LTM) target cell indicated in an LTM cell switch command. In one example, T_{RRC} may be the time for ASN.1 decoding and validity/compliance check for the RRC configuration of the LTM target cell indicated in the LTM cell switch command. In one example, T_{RRC} may be the applicable RRC procedure delay.

In some implementations, the UE may wait for a random access channel occasion (RO) (e.g., a RACH occasion or a Physical Random Access Channel (PRACH) occasion) of a target network node and transmit a preamble on the RO of the target network node after performing the second part of the handover processing and a waiting time T_{IU}. In one example, T_{IU} may be the interruption uncertainty in acquiring the first available PRACH occasion in the new cell. In these implementations, the interruption time (i.e., Tₚₐᵣₜ₂ + T_{IU} in FIG. 2A) may start from the second part of the handover processing and end at transmitting the RO (e.g., RACH or PRACH) to the target cell (i.e., transmitting a preamble on the RO of the target cell/network node). Accordingly, the interruption time may be reduced thereby.

FIG. 2B is a diagram depicting example scenarios under schemes in accordance with implementations of the present disclosure. In some implementations, the UE may perform the necessary procedures that may have no interruption on the source network node before performing the second part of the handover processing. Compared with in FIG. 2A, the interruption time may be further reduced hereby. In these implementations, the interruption time (i.e., Tₚₐᵣₜ₂ in FIG. 2B) may start from the second part of the handover processing and end at transmitting the PRACH to the target cell. The HO delay (i.e., T_{necessary} + T_{IU} + Tₚₐᵣₜ₂) may be defined from performing necessary procedures to finishing the second part of the handover processing.

FIG. 2C is a diagram depicting example scenarios under schemes in accordance with implementations of the present disclosure. In some implementations, the UE may perform downlink (DL) synchronization during T_{DL} _{synchronization} after receiving and/or decoding the handover command, the cell switch command, or triggering a handover or cell switch procedure. In some implementations, the UE performing the DL synchronization may include searching the target network node and acquiring timing information of the target network node. The time duration T_{DL} _{synchronization} may include T_{searc}ₕ, T_{track}, and T_{margin}. T_{searc}ₕ may be the time required to search the target cell in an event that the target cell is not known when the handover command is received by the UE. T_{track} and T_{margin} may be the time for fine time tracking and acquiring complete timing information of the target cell, T_{track} may be the time waiting for the RS for time tracking, and T_{margin} may be the time for the RS processing.

In some implementations, the UE may perform the DL synchronization in parallel with the RRC processing and the first part of the handover processing after receiving the handover command or the cell switch command. In some implementations, the UE may perform the DL synchronization in parallel with the RRC processing or the first part of the handover processing after receiving the handover command or the cell switch command. In some implementations, the UE may perform the DL synchronization in parallel with the RRC processing and the first part of the handover processing after receiving and decoding the handover command or the cell switch command. In some implementations, the UE may perform the DL synchronization in parallel with the RRC processing or the first part of the handover processing after receiving and decoding the handover command or the cell switch command. In some implementations, the UE may perform the DL synchronization in parallel with the RRC processing and/or the first part of the handover processing after triggering the handover procedure or the cell switch procedure. The handover procedure or the cell switch procedure may be triggered by cell change command, predefined condition(s), or measurement report(s).

Then, the UE may perform a Physical Random Access Channel (PRACH) transmission (or a Random Access Channel (RACH) transmission) on the target network node (i.e., transmitting a RACH/PRACH preamble on the RO of the target network node) just after performing the second part of the handover processing. In other words, the UE may perform the second part of the handover processing just before the RO occasion (e.g., RACH occasion or PRACH occasion) on the target cell/network node. Then the UE may transmit PRACH to the target cell. In these implementations, the UE may perform the DL synchronization, the RRC processing, the first part of the handover processing, and the synchronization without interruption with the source cell/network node. In these implementations, the interruption time may start from the second part of the handover processing, which will cause interruption on the source cell/network node, and end at transmitting the PRACH to the target cell/network node. Accordingly, the interruption time may be reduced thereby.

In some implementations, the UE may activate a preconfigured gap (e.g., measurement gap) by a handover command (or cell change command), or a predefined condition, or a measurement report. The preconfigured gap may be activated for the DL synchronization on the target cell/network node in an event that the RF retuning is needed. In these implementations, the UE may perform the DL synchronization on a first carrier (e.g., receiving an SSB from the target cell) and may perform the RRC processing and the first part of the handover processing on a second carrier. The first carrier may be the same as the second carrier. In this scenario, the interruption time caused on the source cell may further include the time for performing the DL synchronization on the target cell/network node in an event that the RF retuning is needed, and the UE performs the DL synchronization in parallel with the RRC processing and the first part of the handover processing.

In some implementations, the UE may use an autonomous measurement gap (e.g., determined by the UE itself) for the DL synchronization on the target cell in an event that the RF retuning is needed. In these implementations, the UE may perform the DL synchronization on a first carrier (e.g., receiving an SSB from the target cell) and perform the RRC processing and the first part of the handover processing on a second carrier. The first carrier may be the same as the second carrier. In this scenario, the UE performs the DL synchronization in parallel with the RRC processing and the first part of the handover processing, and the interruption time caused on the source cell may further include the time for performing the DL synchronization on the target cell/network node in an event that the RF retuning is needed.

FIG. 2D is a diagram depicting example scenarios under schemes in accordance with implementations of the present disclosure. In some implementations, the UE may perform the DL synchronization sequentially with the RRC processing and the first part of the handover processing after receiving and/or decoding the handover command, the cell switch command, or triggering a handover procedure or a cell switch procedure. In some implementations, the UE may perform the DL synchronization sequentially with the RRC processing or the first part of the handover processing after receiving and/or decoding the handover command, the cell switch command, or triggering the handover procedure or the cell switch procedure.

Then the UE may perform a RACH/PRACH transmission on the target network node just after performing the second part of the handover processing. In other words, the UE may perform the second part of the handover processing just before the RO occasion (e.g., RACH occasion or PRACH occasion) on the target cell/network node. In these implementations, the UE may perform the DL synchronization, the RRC processing, and the first part of the handover processing. In these implementations, the interruption time may start from the second part of the handover processing, which will cause interruption on the source cell/network node, and end at transmitting the RO (e.g., RACH or PRACH) to the target cell/network node (i.e., transmitting a preamble on the RO of the target cell/network node). Accordingly, the interruption time may be reduced thereby.

FIG. 2E is a diagram depicting example scenarios under schemes in accordance with implementations of the present disclosure. In this scenario, the RO (e.g., RACH or PRACH) on the target cell may not be needed (i.e., the UE may not need to transmit PRACH to the target cell/network node during handover). In some implementations, the UE may receive a reference signal (RS) from the target network node, and the UE may perform the second part of the handover processing just before receiving the RS from the target network node. In other words, the UE may perform the second part of the handover processing just before an RS occasion on the target cell for DL synchronization.

In some implementations, the UE may perform the RRC processing, the first part of the handover processing, and the synchronization after receiving and/or decoding the handover command or the cell switch command or triggering a handover procedure or a cell switch procedure, and before performing the second part of the handover processing.

In some implementations, the interruption time may start from the second part of the handover processing and end at receiving the RS from the target cell/network node. In some implementations, the interruption time may start when the UE performs the second part of the handover processing, and end when the UE receives the RS and finishes T/F tracking on the target cell. Accordingly, the interruption time may be reduced thereby.

FIG. 2F is a diagram depicting example scenarios under schemes in accordance with implementations of the present disclosure. In this scenario, the UE may not transmit a preamble on the RO of the target cell/network node during the handover/cell switch procedure. In some implementations, the UE may receive the RS from the target network node for DL synchronization, and the UE may perform the second part of the handover processing just after receiving the RS from the target network node. In other words, the UE may perform the second part of the handover processing just after the RS occasion on the target cell for DL synchronization. In some implementations, the UE may receive the RS from the target network node before performing the second part of the handover processing. In one example, the UE may perform the second part of the handover processing a time gap later than receiving the RS from the target network node.

In some implementations, the UE may perform the RRC processing, the first part of the handover processing, and the synchronization after receiving and/or decoding the handover command or the cell switch command, triggering a handover procedure or a cell switch procedure, and before receiving the RS from the target network node. In some implementations, the interruption time may start from receiving the RS (i.e., start from the RS occasion) and end after finishing performing the second part of the handover processing. Accordingly, the interruption time may be reduced thereby.

In some implementations, the UE may perform the RRC processing (e.g., ASN.1 decoding and/or validity check) and/or the first part of the handover processing (e.g., partial L1/L2/L3 processing that will cause no interruption on source cell) after receiving the handover command or the cell change command and some procedures (e.g., decoding the commands). Then the UE may perform the DL synchronization and the second part of the handover processing (e.g., another part of L1/L2/L3 processing, including L2 and/or L3 reconfiguration, and/or RF retuning, and/or baseband retuning, and/or security update, etc., which will cause interruption on the source cell/source network node), just after the RS occasion on the target cell/target network node. In some implementations, the interruption time may start from performing the DL synchronization when the RF retuning for the DL synchronization is needed and end after finishing the second part of the handover processing. Accordingly, the interruption time may be reduced thereby.

### Illustrative Implementations

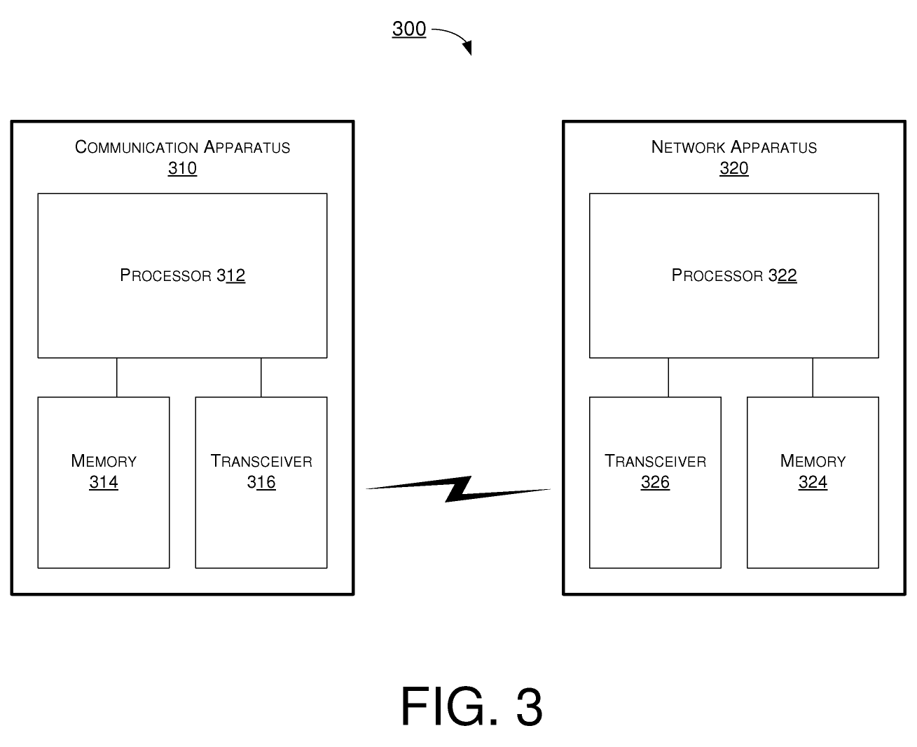

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to improving handover processing or cell switch with respect to UE and network apparatus in mobile communications, including scenarios/schemes described above as well as processes 400, 500 and 600 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including improving handover processing or cell switch in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In other words, processor 312 may transceive the data such as configuration, message, signal, information, indicator, etc. via transceiver 316. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In other words, processor 322 may transceive the data such as configuration, message, signal, information, indicator, etc. via transceiver 326. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, each of memory 314 and memory 324 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314 and memory 324 may include a type of read-only memory (ROM) such as mask ROM, programmable ROM (PROM), erasable programmable ROM (EPROM) and/or electrically erasable programmable ROM (EEPROM). Alternatively, or additionally, each of memory 314 and memory 324 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

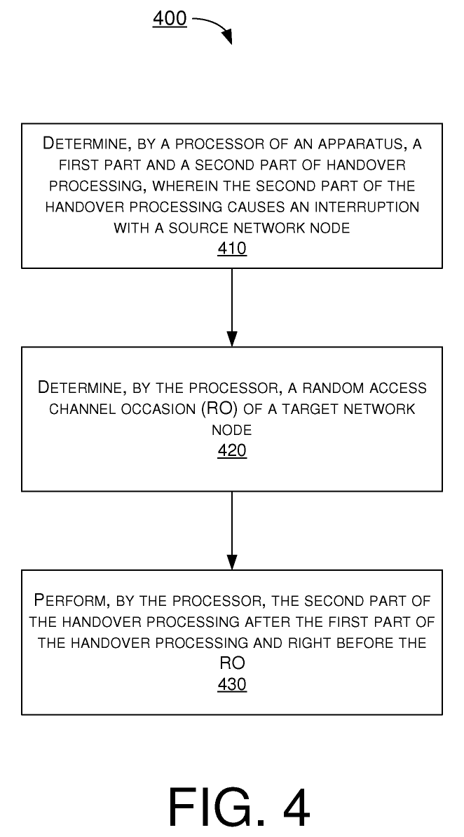

FIG. 4 illustrates an example process 400 in accordance with an implementation of the present disclosure. Process 400 may be an example implementation of above scenarios/schemes, whether partially or completely, with respect to improving handover processing or cell switch of the present disclosure. Process 400 may represent an aspect of implementation of features of communication apparatus 310. Process 400 may include one or more operations, actions, or functions as illustrated by one or more of blocks 410 to 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At block 410, process 400 may involve processor 312 of communication apparatus 310 determining a first part and a second part of handover processing. The second part of the handover processing may cause an interruption with a source network node. Process 400 may proceed from block 410 to block 420.

At block 420, process 400 may involve processor 312 of communication apparatus 310 determining a random access channel occasion (RO) of a target network node. Process 400 may proceed from block 420 to block 430.

At block 430, process 400 may involve processor 312 of communication apparatus 310 performing the second part of the handover processing after the first part of the handover processing and right before the RO. The network apparatus 320 may be the source network node or the target network node.

In some implementations, process 400 may involve processor 312 of communication apparatus 310 triggering a handover procedure or a cell switch procedure. Process 400 may involve processor 312 of communication apparatus 310 performing the first part of the handover processing that may have no interruption on the source network node after triggering the handover procedure or the cell switch procedure. Process 400 may involve processor 312 of communication apparatus 310 transmitting, via transceiver 316, a preamble on the RO of the target network node after performing the second part of the handover processing. The handover procedure may be triggered by cell change, predefined condition(s), or measurement report(s).

In some implementations, process 400 may involve processor 312 of communication apparatus 310 transmitting PRACH after performing the second part of the handover processing.

In some implementations, process 400 may involve processor 312 of communication apparatus 310 performing a synchronization (e.g., downlink or uplink synchronization) before performing the second part of the handover processing.

In some implementations, the second part of handover processing may be triggered by a cell change command, a predefined condition, or a measurement report.

In some implementations, process 400 may involve processor 312 of communication apparatus 310 activating a preconfigured measurement gap according to the cell change command, the predefined condition, or the measurement report for a downlink synchronization on the target network node, e.g., when the RF retuning is needed.

In some implementations, process 400 may involve processor 312 of communication apparatus 310 determining an autonomous measurement gap for a downlink synchronization on the target network node, e.g., when the RF retuning is needed.

In some implementations, process 400 may involve processor 312 of communication apparatus 310 performing a downlink synchronization. Process 400 may involve processor 312 of communication apparatus 310 performing at least one of an RRC processing and the first part of the handover processing in parallel with the downlink synchronization. The RRC processing may include an ASN.1 decoding and/or validity check.

In some implementations, process 400 may involve processor 312 of communication apparatus 310 performing a downlink synchronization after performing the first part of the handover processing. Process 400 may involve processor 312 of communication apparatus 310 performing a PRACH transmission after performing the downlink synchronization.

In some implementations, process 400 may involve processor 312 of communication apparatus 310 receiving, via transceiver 316, a reference signal (RS) from the target network node. The second part of the handover processing may be performed before receiving the RS from the target network node or after receiving the RS from the target network node.

In some implementations, process 400 may involve processor 312 of communication apparatus 310 performing a downlink synchronization before performing the second part of the handover processing. The performing of the downlink synchronization may further include searching the target network node and acquiring timing information of the target network node.

In some implementations, process 400 may involve processor 312 of communication apparatus 310 performing a downlink synchronization before performing the first part of the handover processing.

In some implementations, the second part of the handover processing may include at least RF retuning of the apparatus.

In some implementations, process 400 may involve processor 312 of communication apparatus 310 performing the DL synchronization in parallel with the RRC processing and the first part of the handover processing.

In some implementations, process 400 may involve processor 312 of communication apparatus 310 performing the DL synchronization in parallel with the RRC processing or the first part of the handover processing.

In some implementations, process 400 may involve processor 312 of communication apparatus 310 activating a preconfigured gap by a handover command (or a cell change command), a predefined condition, or a measurement report. The preconfigured gap may be activated for DL synchronization on the target cell, e.g., in an event that RF retuning is needed. In these implementations, the DL synchronization may be performed on a first carrier, and the RRC processing and the first part of the handover processing may be performed on a second carrier. The first carrier may be the same as the second carrier.

In some implementations, an autonomous measurement gap may be determined for DL synchronization on the target cell, e.g., in an event that RF retuning is needed. In these implementations, the DL synchronization may be performed on a first carrier, and the RRC processing and the first part of the handover processing may be performed on a second carrier. The first carrier may be the same as the second carrier.

In some implementations, process 400 may involve processor 312 of communication apparatus 310 performing the DL synchronization in sequence with the RRC processing and the first part of the handover processing.

In some implementations, process 400 may involve processor 312 of communication apparatus 310 performing the DL synchronization in sequence with the RRC processing or the first part of the handover processing.

In some implementations, the first and second parts of the handover processing may include applying parameters of the target network node and changing L1 and L2 configurations of the apparatus.

In some implementations, process 400 may involve processor 312 of communication apparatus 310 performing the RRC processing (e.g., the ASN.1 decoding and/or validity check) before performing the second part of the processing.

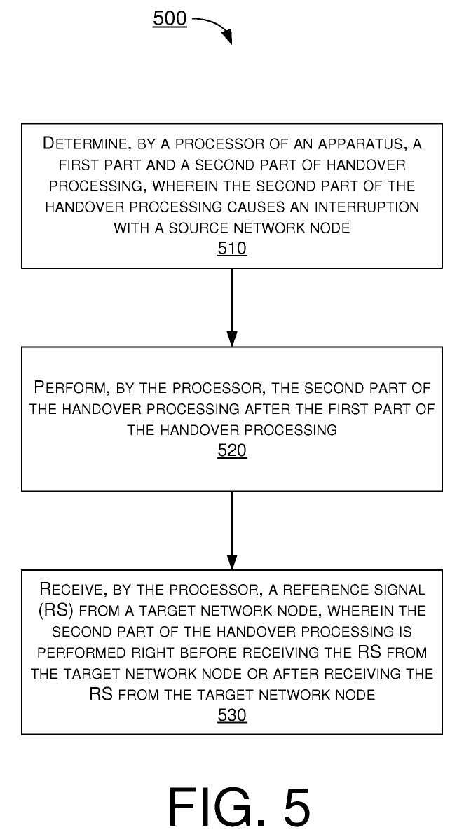

FIG. 5 illustrates an example process 500 in accordance with an implementation of the present disclosure. Process 500 may be an example implementation of above scenarios/schemes, whether partially or completely, with respect to improving handover processing or cell switch of the present disclosure. Process 500 may represent an aspect of implementation of features of communication apparatus 310. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At block 510, process 500 may involve processor 312 of communication apparatus 310 determining a first part and a second part of handover processing. The second part of the handover processing may cause an interruption with a source network node. Process 500 may proceed from block 510 to block 520.

At block 520, process 500 may involve processor 312 of communication apparatus 310 performing the second part of the handover processing after the first part of the handover processing. Process 500 may proceed from block 520 to block 530.

At block 530, process 500 may involve processor 312 of communication apparatus 310 receiving an RS from a target network node. The second part of the handover processing may be performed right before receiving the RS from the target network node or after receiving the RS from the target network node. The network apparatus 320 may be the source network node or the target network node.

In some implementations, the second part of the handover processing may include at least RF retuning of communication apparatus 310.

In some implementations, process 500 may involve processor 312 of communication apparatus 310 triggering a handover procedure. Process 500 may involve processor 312 of communication apparatus 310 performing the first part of the handover processing that may have no interruption on the source network node after triggering the handover procedure.

In some implementations, the second part of the handover processing may be triggered by a cell change command, a predefined condition, or a measurement report.

In some implementations, process 500 may involve processor 312 of communication apparatus 310 activating a preconfigured measurement gap by the cell change command, the predefined condition, or the measurement report for a downlink synchronization on the target network node. The target network node may be an inter-frequency target cell.

In some implementations, process 500 may involve processor 312 of communication apparatus 310 activating the preconfigured measurement gap for the downlink synchronization on the target network node in an event that the second part of the handover processing includes at least RF retuning of communication apparatus 310.

In some implementations, process 500 may involve processor 312 of communication apparatus 310 determining an autonomous measurement gap for a downlink synchronization on the target network node. The target network node may be an inter-frequency target cell.

In some implementations, process 500 may involve processor 312 of communication apparatus 310 determining the autonomous measurement gap for the downlink synchronization on the target network node in an event that the second part of the handover processing includes at least RF retuning of communication apparatus 310.

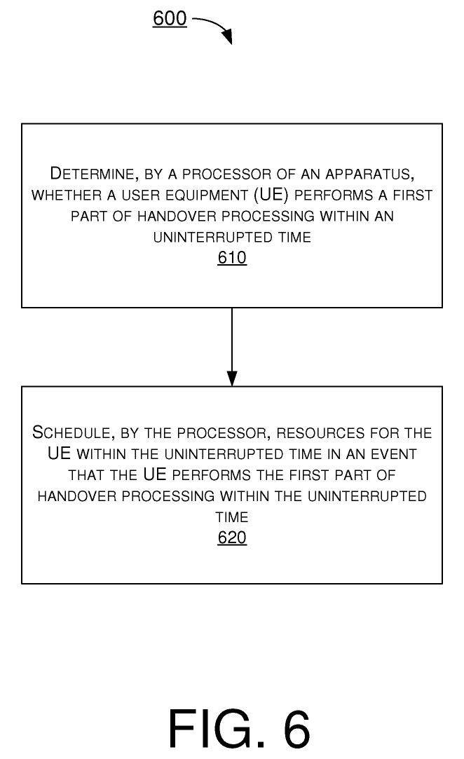

FIG. 6 illustrates an example process 600 in accordance with an implementation of the present disclosure. Process 600 may be an example implementation of above scenarios/schemes, whether partially or completely, with respect to improving handover processing or cell switch of the present disclosure. Process 600 may represent an aspect of implementation of features of network apparatus 320. Process 600 may include one or more operations, actions, or functions as illustrated by one or more of blocks 610 to 620. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 320 or any suitable network device or machine type devices. Solely for illustrative purposes and without limitation, process 600 is described below in the context of network apparatus 320. Process 600 may begin at block 610.

At block 610, process 600 may involve processor 322 of network apparatus 320 determining whether a UE performs a first part of handover processing within an uninterrupted time. Process 600 may proceed from block 610 to block 620.

At block 620, process 600 may involve processor 322 of network apparatus 320 scheduling resources for the UE within the uninterrupted time in an event that the UE performs the first part of handover processing within the uninterrupted time.

In some implementations, process 600 may involve processor 322 of network apparatus 320 determining not to schedule the resources in an event that the UE starts to perform a second part of the handover processing within an interrupted time with the UE. The first part of the handover processing may be earlier than the second part of the handover processing.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a first part and a second part of handover processing, wherein the second part of the handover processing causes an interruption with a source network node;
determining, by the processor, a random access channel occasion (RO) of a target network node; and
performing, by the processor, the second part of the handover processing after the first part of the handover processing and right before the RO.

2. The method of claim 1, wherein the second part of handover processing is triggered by a cell change command, a predefined condition, or a measurement report.

3. The method of claim 2, further comprises:
activating, by the processor, a preconfigured measurement gap according to the cell change command, the predefined condition, or the measurement report for a downlink synchronization on the target network node.

4. The method of claim 1, further comprises:
determining, by the processor, an autonomous measurement gap for a downlink synchronization on the target network node.

5. The method of claim 1, further comprises:
performing, by the processor, a downlink synchronization; and
performing, by the processor, at least one of a Radio Resource Control (RRC) processing and the first part of the handover processing in parallel with the downlink synchronization.

6. The method of claim 1, further comprises:
performing, by the processor, a downlink synchronization after performing the first part of the handover processing.

7. The method of claim 1, further comprises:
performing, by the processor, a downlink synchronization before performing the second part of the handover processing, wherein the performing of the downlink synchronization further comprises at least one of:
searching, by the processor, the target network node; and
acquiring, by the processor, timing information of the target network node.

8. The method of claim 1, further comprises:
performing, by the processor, a downlink synchronization before performing the first part of the handover processing.

9. The method of claim 1, wherein the second part of the handover processing comprises at least Radio Frequency (RF) retuning of the apparatus.

10. A method, comprising:
determining, by a processor of an apparatus, a first part and a second part of handover processing, wherein the second part of the handover processing causes an interruption with a source network node;
performing, by the processor, the second part of the handover processing after the first part of the handover processing; and
receiving, by the processor, a reference signal (RS) from a target network node, wherein the second part of the handover processing is performed right before receiving the RS from the target network node or after receiving the RS from the target network node.

11. The method of claim 10, wherein the second part of the handover processing comprises at least Radio Frequency (RF) retuning of the apparatus.

12. The method of claim 10, wherein the second part of the handover processing is triggered by a cell change command, a predefined condition, or a measurement report.

13. The method of claim 12, further comprises:
activating, by the processor, a preconfigured measurement gap according to the cell change command, the predefined condition, or the measurement report for a downlink synchronization on the target network node.

14. The method of claim 10, further comprises:
determining, by the processor, an autonomous measurement gap for a downlink synchronization on the target network node.

15. An apparatus, comprising:
a transceiver, during operation, wirelessly communicates with a wireless network; and
a processor communicatively coupled to the transceiver such that, during operation, the processor performs operations comprising:
determining a first part and a second part of handover processing, wherein the second part of handover processing causes an interruption with a source network node;
determining a random access channel occasion (RO) of a target network node; and
performing the second part of the handover processing after the first part of the handover processing and right before the RO.

16. The apparatus of claim 15, wherein the processor is further configured to perform operations comprising:
performing a downlink synchronization; and
performing at least one of a Radio Resource Control (RRC) processing and the first part of the handover processing in parallel with performing the downlink synchronization.

17. The apparatus of claim 15, wherein the processor is further configured to perform operations comprising:
performing a downlink synchronization after performing the first part of the handover processing.

18. The apparatus of claim 15, wherein the processor is further configured to perform operations comprising:
performing a downlink synchronization before performing the second part of the handover processing, wherein, in performing the downlink synchronization, the processor is further configured to perform at least one of operations comprising:
searching the target network node; and
acquiring timing information of the target network node.

19. The apparatus of claim 15, wherein the processor is further configured to perform operations comprising:
performing a downlink synchronization before performing the first part of the handover processing.

20. A method, comprising:
determining, by a processor of an apparatus, whether a user equipment (UE) performs a first part of handover processing within an uninterrupted time; and
scheduling, by the processor, resources for the UE within the uninterrupted time in an event that the UE performs the first part of handover processing within the uninterrupted time.
